(19) United States
(12) Patent Application Publication
(10) Pub. No.: US 2013/0127945 A1
(43) Pub. Date: May 23, 2013

(54) REFRIGERATED INK JET DEVICE AND METHOD IMPLEMENTING SUCH A DEVICE

(71) Applicant: Commissariat A L'Energie Atomique Et Aux Energies Alternatives, Paris (FR)

(72) Inventors: Rémi VINCENT, Grenoble (FR); Anne-Gaëlle MERCIER, Grenoble (FR); Christine NAYOZE, La Riviere (FR)

(73) Assignee: Commissariat A L'Energie Atomique Et Aux Energies Alternatives, Paris (FR)

(21) Appl. No.: 13/719,628

(22) Filed: Dec. 19, 2012

Related U.S. Application Data
(63) Continuation of application No. PCT/FR2011/051719, filed on Jul. 19, 2011.

(30) Foreign Application Priority Data
Sep. 29, 2010 (FR) 10.57846

(51) Int. Cl. C09D 11/02

(52) U.S. Cl. CPC C09D 11/033
USPC 347/17; 347/100

(57) ABSTRACT

In the inkjet printing method according to the invention, ink is ejected at a temperature lower than or equal to 20° C., advantageously ranging between −20° C. and 20° C. The corresponding device comprises a temperature regulation system selected from among: a system for cooling the ink reservoir; a system for cooling the nozzles, advantageously with an in situ Peltier effect; a climatic chamber, advantageously at controlled temperature and humidity, intended to receive the printing device or the nozzles only.

### FIELD OF THE INVENTION

The present invention provides a method and a device enabling to perform an inkjet printing with no nozzle clogging, including by using a humectant-free ink. More specifically, the invention provides ejecting an ink at a temperature lower than the ambient temperature.

Advantageously, the present invention finds an application in the field of electronics, for example, to form catalytic layers in PEMFC-type cells (Polymer Electrolyte Membrane Fuel Cells).

### BACKGROUND

The general principle of the inkjet technique is to project and direct small drops of ink by means of a computer. Inkjet may reproducibly dispense spherical drops having a diameter ranging between 25 and 125 micrometers (from 8 picoliters to 1 nanoliter), at a frequency ranging from 25 kHz (drop on demand, or DOD) to 1 MHz (continuous inkjet).

The digital nature of the inkjet technology has many advantages over conventional technologies such as serigraphy, flexography, and offset. With neither mask, nor screen, the supports are printed by means of CAD software storing the data.

The inks used in an inkjet process are formed of at least one humectant, for avoiding for the ink to dry at the outlet of the nozzle, and thus for preventing the clogging thereof. Due to their high boiling temperature and their good water affinity, ethylene glycol, glycerol, and propylene glycol are generally used as humectants in ink formulations.

Document U.S. Pat. No. 6,846,851, which provides new humectants capable of being treated with ultraviolets, such as polyalkylene glycol acrylates and polyether acrylates, gives the example of a formulation which, without humectant, clogs the nozzle.

Similarly, document US 2005/0187312 reports that too low a ratio of humectant in the ink generates too high an evaporation rate in the nozzle, thus resulting in the clogging thereof.

It is thus clearly established for those skilled in the art that ink intended for the inkjet method requires the presence of a humectant. Further, the presence of a humectant in the ink is generally not disturbing, especially in standard applications such as graphic art.

The inkjet method also finds applications in the field of fuel cells and of proton exchange membrane (PEM) electrolysis. In such a context, the ink used comprises catalysts such as platinum, which are particularly sensitive to contamination by physisorption. In other words, the introduction, in such an ink, of a product having a high boiling point, as is the case for humectants, generally adversely affects the cell performance by another mechanism than contamination by physisorption. Indeed, during the drying and on forming of the active layer, such products do not totally evaporate and stay in the porosity of the active layer. The decrease of this porosity thus decreases the capacity of gases to diffuse towards catalytic sites.

Inks intended for such applications thus appear to have to be formulated with the least possible additives, and if possible with no humectant.

Thus, Chisaka and Daiguji (M. Chisaka and H. Daiguji, Effect of glycerol on micro/nano structures of catalyst layers in polymer electrolyte membrane fuel cells, Electrochim. Acta 51 (2006), pp. 4828-4833) have shown that too high a ratio of glycerol in the ink adversely affects the cell performance. It provides, to overcome this problem, evacuating the residual glycerol from the active layer by vapor extraction.

Similarly, Y.-G. Yoon et al. (Y.-G. Yoon, G.-G. Park, T.-H. Yang, J.-N. Han, W.-Y. Lee, C.-S. Kim, Effect of pore structure of catalyst layer in a PEMFC on its performance, Int. J. Hydrogen Energy 28 (2003) pp 657-662) illustrate the decrease of the performance of a fuel cell after the introduction of 27 and 60% of ethylene glycol in the formulation of a catalytic ink.

As already mentioned, it appears to be necessary, to form fuel cell electrodes by means of the inkjet method, to decrease as much as possible the humectant ratio, or even to suppress it.

To date, however, the only technical solution provided is to keep the presence of a humectant in the ink and to remove it after the layer has been printed.

There thus is an obvious need to find technical solutions enabling to avoid ink clogging, especially in the inkjet device nozzles, if possible by eliminating the presence of humectants from the ink formulation.

### SUMMARY OF TILE INVENTION

The present invention is based on the implementation of a temperature regulation system enabling to eject ink at a temperature lower than the ambient temperature, and to thus avoid the evaporation of the solvents and the clogging of the inkjet device nozzles.

In practice, it comprises installing a system for cooling the inkjet device which allows an operation at temperatures ranging between −20° C. and 20° C.

It should be noted that in prior art, inkjet systems having nozzle cooling systems have already been described, however for different purposes. Thus, and as an example, document U.S. Pat. No. 6,648,443 provides a system for regulating the temperature of an inkjet nozzle. This system comprises a heating member, such as for example a resistor and one or several Peltier effects enabling to regulate the temperature by heating or cooling down the nozzle. This system has the advantage of providing a better nozzle temperature regulation, for example, by cooling the nozzle after too high a heating, and thus of improving the reproducibility of the ejection. It also enables to decrease the nozzle temperature after use.

However, in prior art, the possibility of operating inkjet nozzles at temperatures lower than the ambient temperature is never mentioned. Indeed, offhand, an operation at low temperature generates ejection problems due to an inadequate viscosity and surface tension of the ink. On the contrary, those skilled in the art would tend to increase the ink temperature (and thus to heat it up) to have a better ejection capacity.

The present invention thus goes against different prejudices of those skilled in the art, especially the indispensable presence of humectant in the ink formulation and the ejection of ink at high temperature, at least at ambient temperature.

Thus, and according to a first aspect, the present invention relates to an inkjet printing method according to which the ejected ink is at a temperature lower than or equal to 20° C., advantageously ranging between −20° C. and 20° C., and more advantageously still ranging between −20° C. and 10° C.

More specifically, the lower limit for the temperature of the ejected ink is advantageously higher than or equal to −20° C.

At the other limit, preferably, the temperature of the ejected ink is:
strictly lower than 15° C., or even
lower than or equal to 10° C., or even
strictly lower than 10° C.

In other words, while prior art would advocate the printing at a temperature at least equal to the ambient temperature (generally considered as ranging between 25 and 30° C., and possibly going down to as low as 15° C.), and advantageously at least 50° C., the present invention provides an operating temperature lower than the ambient temperature.

The temperature in question is the temperature of the ejected ink, and not the possible temperature at which a device having ink transiting therethrough or stored therein (for example, a reservoir) is maintained.

In the context of the invention and since the technical problem to be solved is the clogging of nozzles with ink, the operating temperature is considered as that of the ink at the time of its ejection. According to the device used, the ink temperature may be adjusted to the claimed values, especially by means of the temperature control at the ink reservoir and/or nozzle level.

Further, the method according to the present invention is characterized in that at such an operating temperature, it is possible to use an ink containing no humectant.

In the context of the invention, that is, the formulation of ink for inkjet printing, a humectant is defined as a compound avoiding the drying of ink at the outlet of the nozzle and enabling to prevent the clogging thereof. Such compounds are especially characterized by their strong water affinity, and preferentially a high boiling temperature. A preferred class of compounds according to the invention is the polyol (or glycol) group, and more specifically ethylene glycol, glycerol, and/or propylene glycol.

According to a preferred embodiment, the invention thus characterizes by combining the suppression of humectants and of the nozzle operation in a temperature range between −20° C. and 20° C., advantageously <15° C., or even ≦10° C., or even <10° C. This operating mode results from the need to use ink only containing solvents capable of evaporating at standard fuel cell operating temperatures (50-80° C.), to avoid any residual contamination of the catalyst or clogging of the electrode porosity.

The minimum −20° C. temperature is partly set by the ink formulation and melting point, the increase of the ratio of certain solvents, such as for example ethanol, enabling to lower this melting point.

The lowering of the ink temperature may cause modifications of its properties, such as for example an increase of its viscosity or the modification of its surface tension, making it more difficult to use in the method. It is then possible to overcome these difficulties by making some modifications to the composition of the ink or to the actual inkjet device:
by decreasing the dry extract in the ink. In other words, the proportion of solvent with respect to the active elements is increased. Thus, and advantageously, the solvent(s) amount to at least 90% by mass of the ink, and even 95%, or even 99%. Complementarily, the dry extract advantageously amounts to less than 10% by mass of the composition, more advantageously still less than 5%, or even less than 1%;
by modifying the ratio of the solvents, for example, by increasing the ratio or by introducing solvents having a lower melting point;
by setting the parameters of the piezoelectric acting on the nozzle.

As already mentioned, the method according to the invention is especially advantageous for the printing of fuel cell catalytic layers, since the performance thereof is affected by the residual presence of humectant. Thus, in this specific case, the ink has the following composition:
a catalyst, advantageously Pt/C;
an ionomer;
a solvent system, advantageously a water/ethanol mixture, more advantageously still with a 50/50 or 25/75 mass ratio. It should be noted that as already mentioned, to modify the ink melting temperature, it is possible to modify this mass ratio, and especially to increase the ethanol ratio, or to introduce another solvent.

Preferably, all solvents present in the solvent system evaporate at the operating temperature of a fuel cell, generally ranging between 50 and 80° C.

However, this method may find other applications, especially those requiring to very accurately control the products present in the dry layer, for example, printed electronics, batteries, effect printings (for security).

According to another aspect, the present invention relates to a device capable of implementing the above-described method.

An inkjet device is typically formed of:
an ink reservoir;
one or several nozzles enabling to eject ink drops;
a system for supplying the nozzle(s) from reservoirs.

The inkjet device according to the invention is further characterized in that is comprises a temperature regulation system enabling to eject ink at a temperature lower than or equal to 20° C., advantageously <15° C., or even ≦10° C., or even <10° C., but advantageously ≧−20° C.

Such a temperature regulation system may take several forms. It may be:
a system for cooling the ink reservoir; and/or
a system for cooling the nozzles, advantageously with an in situ Peltier effect; and/or
a climatic chamber, advantageously at controlled temperature and humidity, intended to receive the printing device, or only the nozzles.

As a result, the claimed method advantageously takes place in a climatic chamber at controlled temperature and humidity.

Further, the use of inkjet nozzles at a temperature lower than the dew point of the ambient air may generate condensation (in the form of water or ice) on the nozzle and modify the ink ejection. Thus, the installation of the nozzles in a conditioned chamber or the surface treatment of these nozzles with a highly hydrophobic material such as, for example, polytetrafluoroethylene (Teflon®), are solutions enabling to avoid such a condensation.

According to another embodiment, the inkjet nozzles of the claimed device are thus covered with a hydrophobic product avoiding condensation, such as for example polytetrafluoroethylene (PFTE), better known under trademark Teflon®.

### BRIEF DESCRIPTION OF THE DRAWING

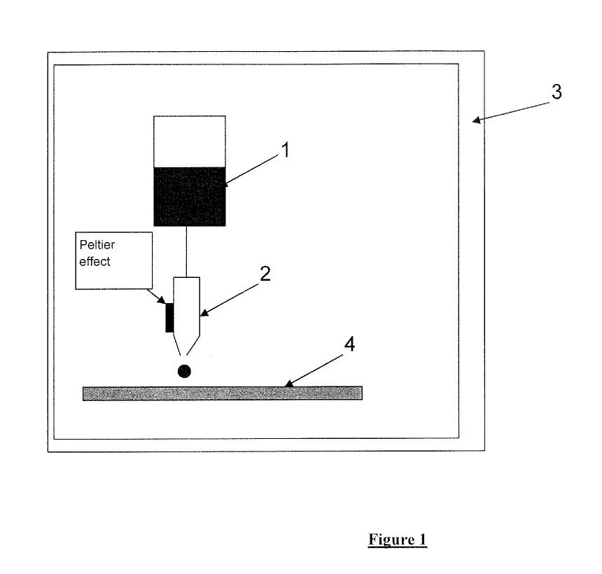

The way in which the invention may be implemented and the resulting advantages will better appear from the following non-limiting embodiments, given as an indication only, in connection with accompanying FIG. 1, which shows an inkjet device according to the invention.

### EMBODIMENTS OF THE INVENTION

The present invention is further illustrated in relation with the printing of a catalytic layer of a PEMFC-type fuel cell electrode. The necessary active elements thus are, on the one hand, a catalyst, advantageously carbon platinum (Pt/C), and on the other hand a Nafion®-type ionomer. Further, the ink is formulated in a binary 50/50 water/ethanol solvent system.

### 1/Inkjet Device Used:

The device used according to the invention is shown in FIG. 1.

The reservoir (1) delivers ink to the nozzle (2) which ejects it drop by drop on the support (4). The reservoir (1) may be refrigerated, for example, by the flowing of a fluid, enabling the ink to be sufficiently cooled to be able to be ejected at the right temperature. It is also possible to use a Peltier effect directly attached to the nozzle (2) to cool down the ink at the time of its ejection. More generally, a use of the system in a refrigerated chamber (3) can also be envisaged. Of course, these different cooling means may be combined.

### 2/Composition of Different Tested Inks:

Different inks have been tested. Their composition is given in the following table:

| Composition (in g) | A | B | C |
|---|---|---|---|
| Pt/C Catalyst | 1 | 1 | 1 |
| Ionomer | 1.13 | 1.13 | 1.13 |
| Water | 6.3 | 6.8 | 13.6 |
| Ethanol | 6.3 | 6.8 | 13.6 |
| Ethylene glycol | 1 | 0 | 0 |

### 2-1/Ink Ejection at a Temperature Higher than the Ambient Temperature

Ink A disclosed in the above table is perfectly well adapted to a standard inkjet system with an ejection temperature of approximately 50° C. In the same standard operating conditions (T=50° C.), ink B, which essentially differs from composition A by the absence of any humectant (ethylene glycol) tends to rapidly clog the inkjet device nozzles.

The comparison of inks A and B shows the positive, or indispensable, presence of a humectant, as already reported in prior art. Indeed, in standard inkjet operating conditions, that is, a temperature higher than the ambient temperature favorable to a good ink ejection capacity, such a humectant avoids nozzle clogging.

### 2-2/Ink Ejection At A Temperature Lower Than The Ambient Temperature

Inks A and B are then ejected by means of the device according to the invention, shown in FIG. 1. The latter has an operating temperature lower than the ambient temperature, on the order of 3° C.

In such operating conditions, inks A and B of course cause ejection difficulties due to a viscosity increased by the temperature decrease. A greater tension is thus necessary for their ejection. However, the inks, and especially ink B, no longer tend to clog the nozzles.

The device and the method according to the invention thus enable to use so-called conventional inks and, remarkably, to suppress the presence of humectant.

The formulation of ink C corresponds to that of ink B, where the solvent quantities have been doubled. Accordingly, the active elements to be printed, as it happens the catalyst and the ionomer (itself diluted to 22%), are diluted.
dry extract of composition B=8.5%;
dry extract of composition C=4.25%.

Composition C no longer has the ejection shortcomings encountered with compositions A and B, and further causes no nozzle clogging problem.

1-11. (canceled)

12. An inkjet printing method according to which:
the ejected ink contains:
a catalyst, advantageously Pt/C;
an ionomer;
a solvent system evaporating at a temperature ranging between 50 and 80° C.;
the ejected ink comprises no humectant;
the ejected ink is at a temperature lower than or equal to 20° C., advantageously ranging between −20° C. and 20° C.

13. The inkjet printing method of claim 12 wherein the temperature of the ejected ink is lower than 15° C., advantageously lower than 10° C.

14. The inkjet printing method of claim 12, wherein the ejected ink comprises no ethylene glycol, glycerol, or propylene glycol.

15. The inkjet printing method of claim 12, wherein the ink comprises at least 95% by mass of solvent.

16. The inkjet printing method of claim 12, wherein said method is implemented for the printing of layers in a fuel cell.

17. The inkjet printing method of claim 12, wherein the solvent system is a water/ethanol mixture, advantageously with a 50/50 or 25/75 mass proportion.

18. The inkjet printing method of claim 12, wherein said method takes place in a climatic chamber, advantageously at controlled temperature and humidity.
